(19) United States
(12) Patent Application Publication
(10) Pub. No.: US 2019/0040952 A1
(43) Pub. Date: Feb. 7, 2019

(54) TRANSMISSION WITH REVERSE GEAR BREAK

(71) Applicant: GM Global Technology Operations LLC, Detroit, MI (US)

(72) Inventors: Ricardo C. Furquim, Sao Paulo (BR); Alexander A. Almeida, Sao Paulo (BR); Iuri C. Portillo, Sau Paulo (BR); Luiz H. Bellatini Fo, Sao Paulo (BR); Sergio R. Marin, Sao Paulo (BR)

(21) Appl. No.: 15/667,232

(22) Filed: Aug. 2, 2017

(51) Int. Cl. F16H 63/30; F16H 3/08; F16H 63/38

(52) U.S. Cl. CPC F16H 63/302; F16H 2003/0822; F16H 63/38; F16H 3/08

(57) ABSTRACT

A multi-speed transmission includes a shaft member, an idler gear connected to the shaft member, an intermediate lever having a first movement and a second movement, the intermediate lever selectively engaging with the shaft member during the first movement and remaining engaged with the shaft member during the second movement, and a synchronizer assembly that is selectively engaged by the intermediate lever during the first movement of the intermediate lever, the synchronizer assembly remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever.

### INTRODUCTION

The present disclosure relates to motor vehicle transmissions. More specifically, the present disclosure relates to motor vehicle transmissions with a reverse gear brake.

A typical manual transmission includes a plurality of shafts, gears, shift mechanisms, synchronizers or other torque-transmitting mechanisms that cooperate to provide a plurality of forward and reverse gear or speed ratios. The transmission input shaft is selectively connected to an engine output shaft and includes a number of gears that are selectively connectable to the input shaft using, for example, synchronizers. The gears of the input shaft mesh with corresponding gears that are selectively connectable to an output shaft. To achieve a particular forward gear ratio between the transmission input and output shafts, the driver operates a shift mechanism, such as a manual shifter, that controls the engagement of the synchronizers with the desired gears. To achieve a reverse gear ratio, an idler gear is used to slide between an input shaft gear and an output shaft gear to reverse the rotational direction of the output shaft, and thus the drive wheels. The idler gear is free to rotate on an idler gear shaft and the idler gear is not necessarily rotating when the idler gear is engaged to the input shaft reverse gear. The input shaft reverse gear, however, is often rotating at a high speed having only recently been disengaged from the engine output shaft. Once the idler gear is meshing with the input shaft reverse gear they will both be rotating at the same high speed. The idler gear must then engage the output shaft gear to complete the torque transfer to the output shaft. As often is the case, however, the output shaft is not rotating and may even be rotating in the opposite direction as the driver may be shifting into reverse before the vehicle has stopped moving forward. The meshing of the fast rotating idler gear with a stationary output gear causes an impact or gear clash that creates noise and grinding that is very objectionable to the driver. Furthermore, gear clash is detrimental to the long term durability of the transmission and is the source of costly customer repair bills.

Thus, while current transmissions that include a mechanism to reduce or eliminate gear clash and premature component wear achieve their intended purpose, there is a need for a new and improved reverse gear brake system that stops the idler movement and input shaft prior to a reverse gear engagement.

### SUMMARY

According to several aspects, a multi-speed transmission includes a shaft member, an idler gear connected to the shaft member, an intermediate lever having a first movement and a second movement, the intermediate lever selectively engaging with the shaft member during the first movement and remaining engaged with the shaft member during the second movement, and a synchronizer assembly that is selectively engaged by the intermediate lever during the first movement of the intermediate lever, the synchronizer assembly remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever.

In an additional aspect of the present disclosure, the synchronizer assembly includes a gear and a sleeve, the gear and the sleeve being coupled when the synchronizer assembly is engage and being uncoupled when the synchronizer assembly is unengaged.

In another aspect of the present disclosure, the sleeve is coupled to a fork with a detent and the intermediate lever includes a ramp, the ramp contacting and pushing against the detent during the first movement of the intermediate lever to engage the synchronizer assembly.

In another aspect of the present disclosure, the ramp remains in contact with the detent during the initial stage of the second movement of the intermediate lever, the ramp moving away from the detent during the final stage of the second movement.

In another aspect of the present disclosure, the ramp has a sloped surface that is in contact with the detent during the first movement of the intermediate lever.

In another aspect of the present disclosure, the sloped surface remains in contact with the detent during the initial stage of the second movement of the intermediate lever.

In another aspect of the present disclosure, the multi-speed transmission includes a shift tower, the intermediate lever moving relative to the shift tower during the first movement and the second movement of the intermediate lever, the intermediate lever being moved in response to an operator of the multi-speed transmission.

In another aspect of the present disclosure, the first movement is generally perpendicular to the second movement of the intermediate lever.

In another aspect of the present disclosure, the synchronizer assembly is a fourth gear synchronizer assembly.

In another aspect of the present disclosure, the first movement of the intermediate lever is a selection movement and the second movement of the intermediate lever is a shift movement.

According to several aspects, a reverse gear braking mechanism for a multi-speed transmission includes a reverse gear shaft member, an idler gear connected to the reverse gear shaft member, an intermediate lever having a first movement and a second movement, the intermediate lever selectively engaging with the reverse gear shaft member during the first movement and remaining engaged with the reverse gear shaft member during the second movement, and a forward gear synchronizer assembly that is selectively engaged by the intermediate lever during the first movement of the intermediate lever, the synchronizer assembly remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever. The forward gear synchronizer assembly creates a braking action to stop a rotation of an input shaft and the idler gear during the first movement and the second movement of the intermediate lever.

In an additional aspect of the present disclosure, the forward gear synchronizer assembly includes a gear and a sleeve, the gear and the sleeve being coupled when the forward gear synchronizer assembly is engage and being uncoupled when the forward gear synchronizer assembly is unengaged.

In another aspect of the present disclosure, the sleeve is coupled to a fork with a detent and the intermediate lever includes a ramp, the ramp contacting and pushing against the detent during the first movement of the intermediate lever to engage the forward gear synchronizer assembly.

In another aspect of the present disclosure, the ramp remains in contact with the detent during the initial stage of the second movement of the intermediate lever, the ramp moving away from the detent during the final stage of the second movement.

In another aspect of the present disclosure, the ramp has a sloped surface that is in contact with the detent during the first movement of the intermediate lever.

In another aspect of the present disclosure, the sloped surface remains in contact with the detent during the initial stage of the second movement of the intermediate lever.

In another aspect of the present disclosure, the first movement is generally perpendicular to the second movement of the intermediate lever.

According to several aspects, a reverse gear braking mechanism for a multi-speed transmission includes a reverse gear shaft member, an idler gear connected to the reverse gear shaft member, an intermediate lever having a first movement and a second movement that is perpendicular to the first movement, the intermediate lever selectively engaging with the reverse gear shaft member during the first movement and remaining engaged with the reverse gear shaft member during the second movement, and a forward gear synchronizer assembly with a gear and a sleeve, the gear and the sleeve being engaged by the intermediate lever during the first movement of the intermediate lever, the gear and the sleeve remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever. The forward gear synchronizer assembly creates a braking action to stop a rotation of an input shaft and the idler gear during the first movement and the second movement of the intermediate lever.

In an additional aspect of the present disclosure, the sleeve is coupled to a fork with a detent and the intermediate lever includes a ramp, the ramp contacting and pushing against the detent during the first movement of the intermediate lever to engage the forward gear synchronizer assembly.

In another aspect of the present disclosure, the ramp remains in contact with the detent during the initial stage of the second movement of the intermediate lever, the ramp moving away from the detent during the final stage of the second movement.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a partial transmission in accordance with the principles of the present invention;

FIG. 2 is a close-up view of the partial transmission shown in FIG. 1;

FIG. 3 is a plan view of an intermediate lever of the transmission shown in FIG. 1;

FIG. 4 is a diagrammatic view of a shift pattern for the transmission shown in FIG. 1;

FIG. 5A is a close-up view of the intermediate lever;

FIG. 5B is a perspective view of a ramp of the intermediate lever;

FIG. 6 is a displacement versus time plot for a selection and shift movement of the transmission shown in FIG. 1; and

FIGS. 7A through 7E illustrate engagement and disengagement of a synchronizer assembly during a reverse gear shift movement of the transmission shown in FIG. 1.

### DETAILED DESCRIPTION

The following description is merely exemplary in nature and is not intended to limit the present disclosure, application, or uses.

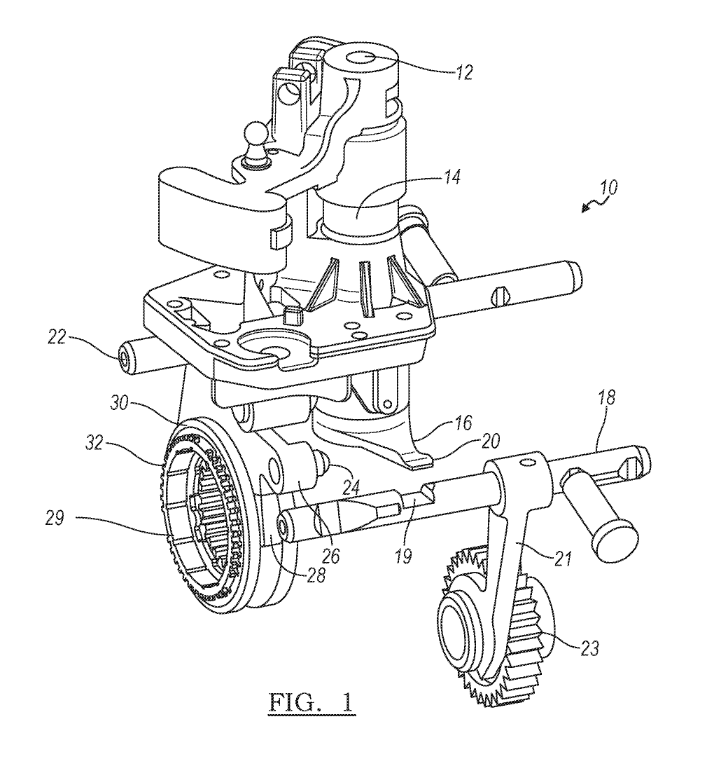

Referring to FIG. 1, a partial transmission 10 of the present invention is illustrated. The transmission 10 includes an input shaft, a main shaft, and an idler shaft. The input shaft is connected to, for example, an engine output shaft and the main shaft is connected to, for example, a vehicle drive shaft that provides torque to one or more drive wheels of the vehicle. The transmission 10 further includes a plurality of gearsets, a plurality of synchronizers, for example, the synchronizer assembly 29, and a plurality of shift rails including a reverse shift rail or shaft 18. The input and main shafts rotatably support the plurality of gear sets. The plurality of synchronizers are supported by the main shaft and are selectively manipulated to achieve a desired forward gear ratio between the input shaft and the main shaft.

The idler shaft supports an idler gear 23. The idler gear 23 is capable of selective movement along the idler shaft to intermesh with both of a reverse gear of the input shaft and a sleeve gear or member on the main shaft. When a reverse gear ratio is desired, the idler gear 23 meshes independently with the reverse gear that is engaged with the input shaft and the sleeve gear that is selectively engaged with the main shaft. When engaged, the idler gear 23 reverses the direction of rotation of the drive shaft of the vehicle. For example, the idler gear 23 is coupled to a shift fork linkage 21 secured to the reverse shift rail or shaft 18.

In the present arrangement, the transmission 10 further includes a fourth gear shift rail or shaft 22 that is coupled to the synchronizer assembly 29 with a fourth gear shift fork linkage 28. The synchronizer assembly 29 includes a sleeve 30 that selectively engages with a gear 32.

The transmission 10 also includes an intermediate lever 16 coupled to a shift shaft 12 housed in a shift tower 14. As such, an operator of the motor vehicle selects a forward or reverse gear by moving a shift lever which in turn moves the shift shaft 12, and hence, the intermediate lever 16, vertically and rotationally relative to the shift tower 14.

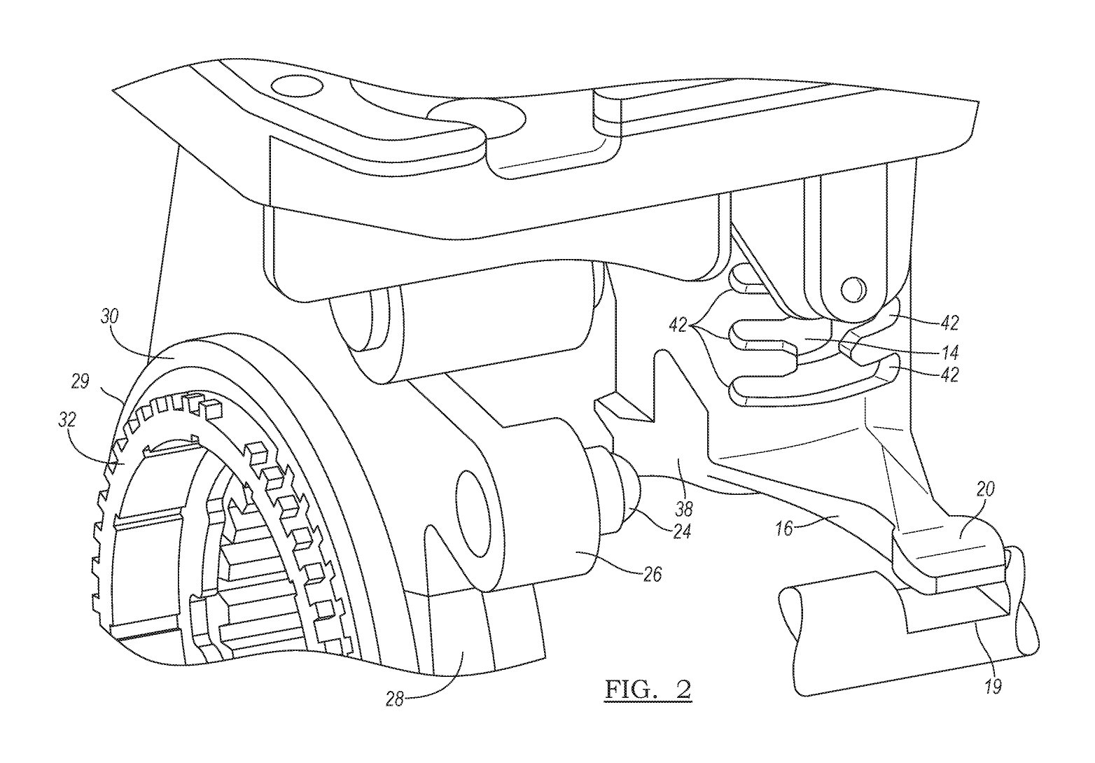

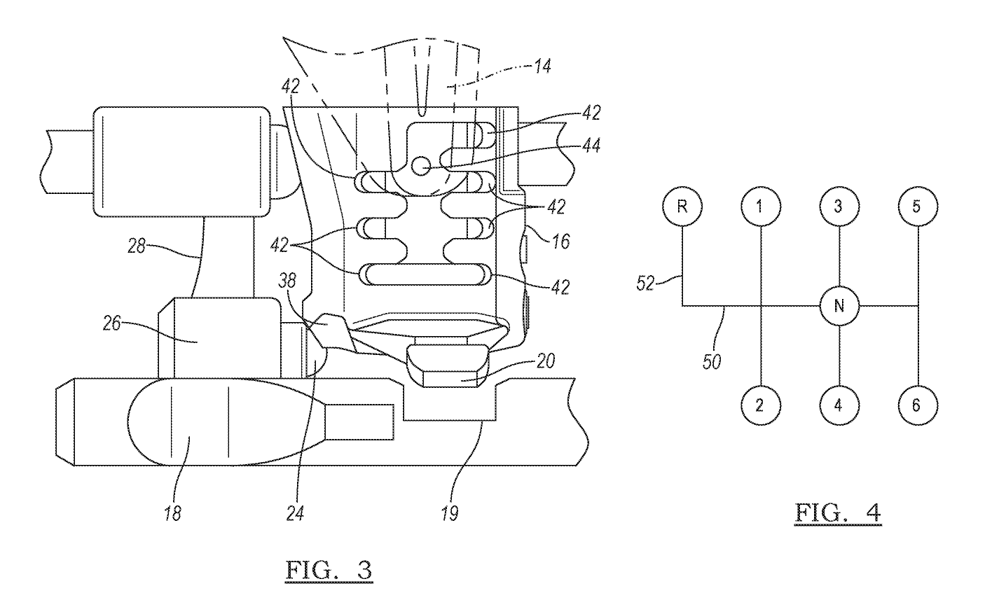

The intermediate lever 16 includes a lever with an end portion 20. The end portion 20 is configured to engage with a slot or notch 19 of the reverse shaft 18. Referring further to FIGS. 2, 3, 5A and 5B, the intermediate lever 16 further includes a ramp 38 that selectively engages with a detent 24 enclosed in a housing 26 of the shift fork linkage 28. The ramp 38 includes a flat portion 56, a relief portion 58 and a slope portion 62. The intermediate lever 20 has a set of slots 42 that engage with a pin 44 on the shift tower 14. In the configuration shown in FIG. 3, engagement of the pin 44 with one of the six lower slots 42 would correspond to one of the forward gear selections (1 through 6) shown in FIG. 4, and the engagement of the pin 44 with the uppermost slot 42 would correspond to a reverse gear selection (R).

The above described arrangement provides for a reverse gear brake system when shifting from a forward gear to a reverse gear. Specifically, as the operator of the motor vehicle shifts from a forward gear to a reverse gear, two movements occur as indicated in FIG. 4, namely there is a first or selection movement 50 followed by a second or shift movement 52. The first movement corresponds to the intermediate lever 16 moving downwards relative to the pin 44 along the central axis of the six lower slots 42 shown in FIG. 3, and the second movement corresponds to the intermediate lever 16 rotating such that the pin 44 engages with the uppermost slot 42 of the intermediate lever 16.

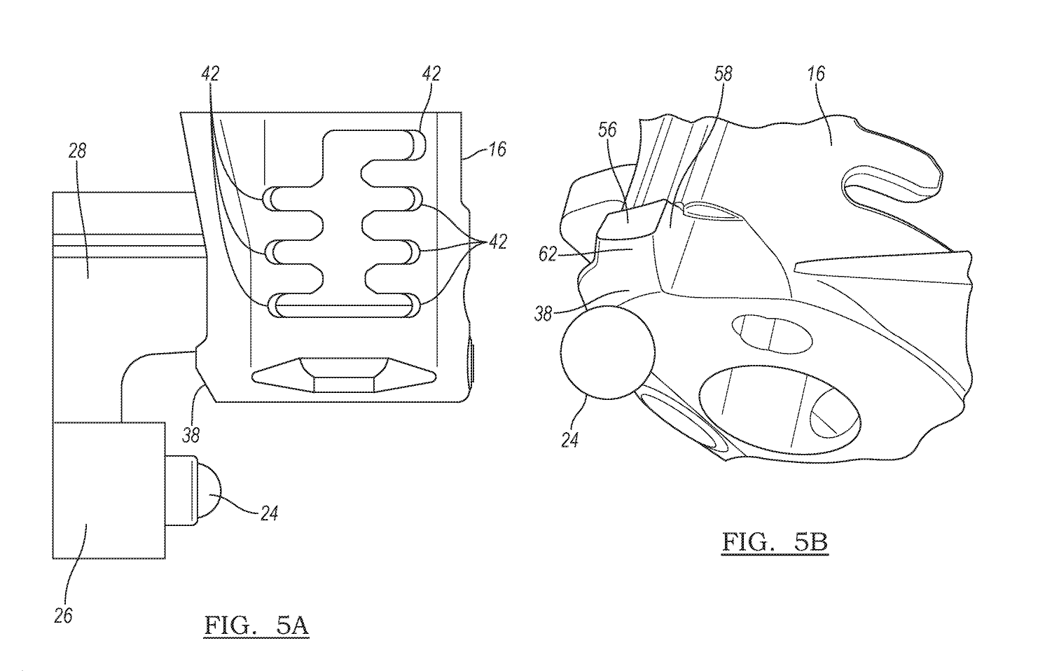

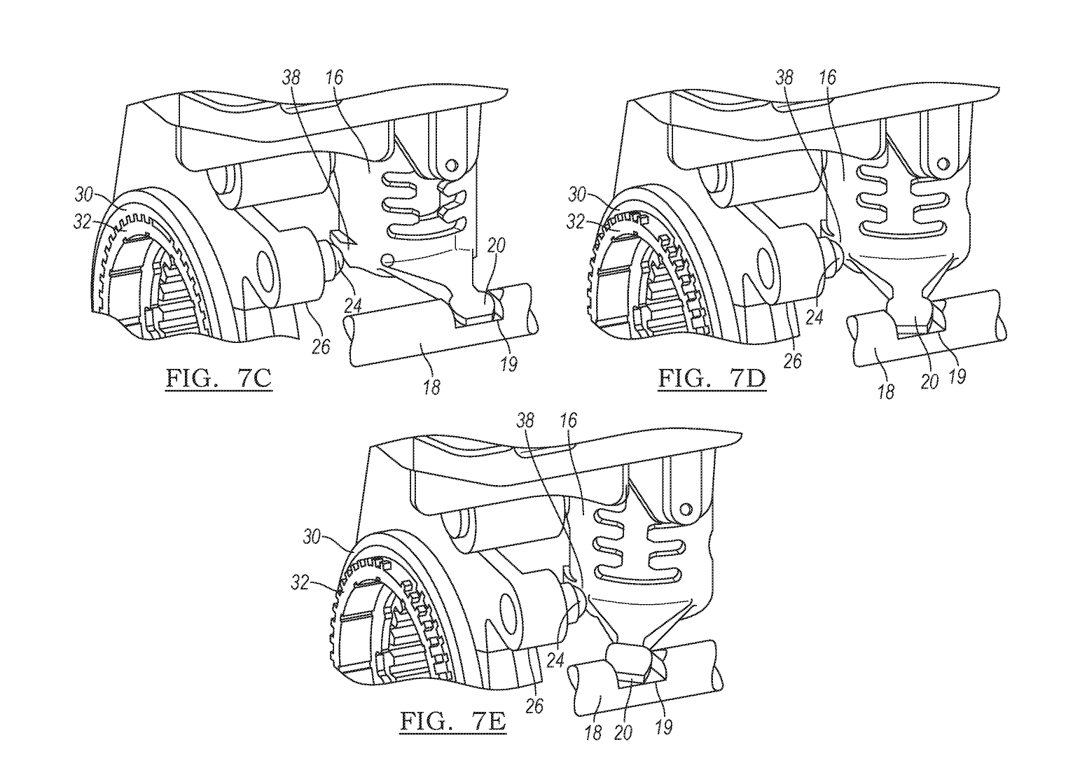

Referring now to FIGS. 5B and 7A through 7E, during the first movement of the intermediate lever 16 relative to the pin 44 of the shift tower 14, the detent 24 engages with the slope portion 62 of the ramp 38 (FIG. 5B) to initiate the reverse gear brake. As such, as the detent 24 moves upwards along the slope portion 62, the end portion 20 engages with the notch 19 of the reverse shaft 18 while the intermediate lever 16 pushes the sleeve 30 via the detent 24 such that the sleeve 30 moves to the left (FIG. 7A) until it is fully engaged with the gear 32 (FIG. 7B). Next, during an initial stage of the second movement, the intermediate lever 16 rotates relative to the shift tower 14 so that the end portion 20 moves the reverse shaft 18 to the left while the detent 24 slides over the slope portion 62 and the sleeve 30 remains engaged with the gear 32 to maintain the reverse gear brake. During a final stage of the second movement, the intermediate lever 16 continues to rotate relative to the shift tower 14 so that the detent 24 moves into a relief portion 58 of the ramp 38. As this occurs, the sleeve 30 moves to the right (FIG. 7D) to initiate the disengagement of the sleeve 30 from the gear 32 until finally the sleeve 30 becomes disengaged from the gear 32 and the reverse shaft 18 fully engages the reverse gear.

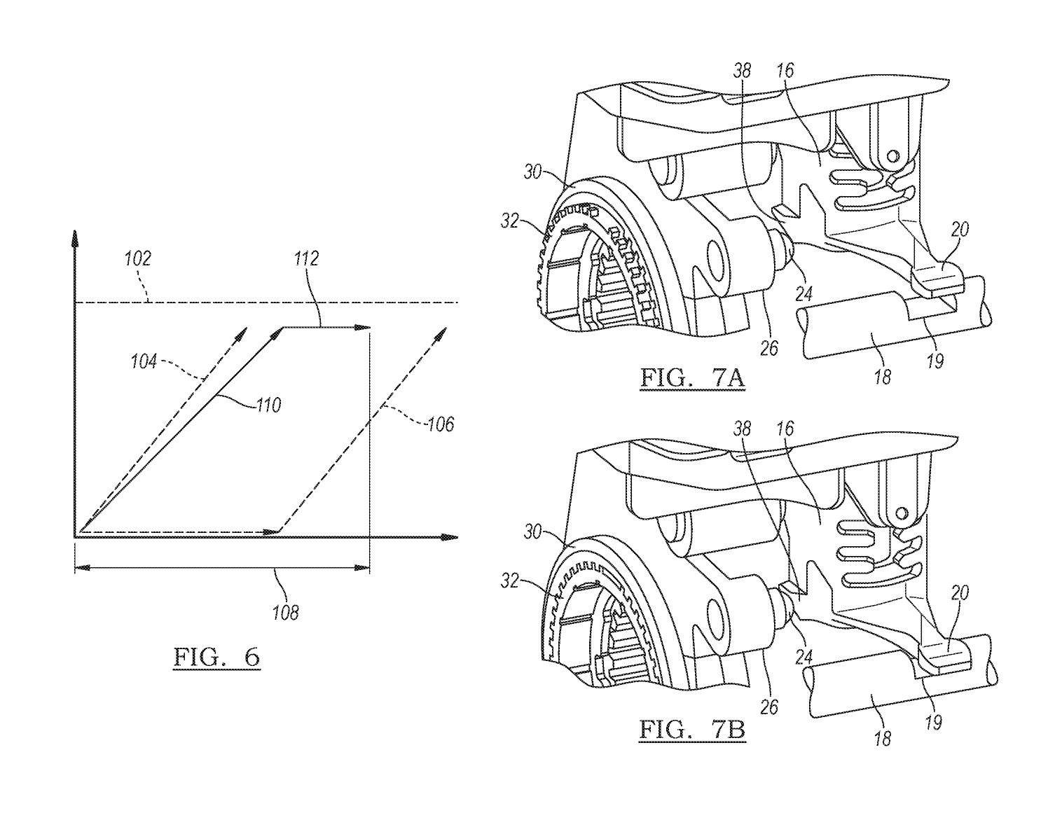

Referring now to FIG. 6, displacement (y or vertical axis) of the sleeve 30 up to a maximum displacement 102 versus time (x or horizontal) axis is shown. During the reverse gear braking action described previously, the braking action begins and continues during the first movement 110 of the intermediate lever 16 and continues during the second movement 112 of the intermediate lever 16 such that the reverse gear braking action occurs over a time period 108. In contrast, in prior reverse gear braking systems with only a shifting movement implementation, the reverse gear braking action delayed until displacement of the intermediate lever 16 as indicated by the dashed line 106. In other prior reverse gear braking systems with only a selection movement implementation, the reverse gear braking action begins at the beginning of the selection movement but ends at the end of the selection movement as indicated by the dashed line 104. In either prior reverse gear braking implementations, the time period for the reverse gear braking action is less than the time period 108 of the reverse gear braking action of the transmission 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A multi-speed transmission comprising:
a shaft member;
an idler gear connected to the shaft member;
an intermediate lever having a first movement and a second movement, the intermediate lever selectively engaging with the shaft member during the first movement and remaining engaged with the shaft member during the second movement; and
a synchronizer assembly that is selectively engaged by the intermediate lever during the first movement of the intermediate lever, the synchronizer assembly remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever.

2. The multi-speed transmission of claim 1 wherein the synchronizer assembly includes a gear and a sleeve, the gear and the sleeve being coupled when the synchronizer assembly is engage and being uncoupled when the synchronizer assembly is unengaged.

3. The multi-speed transmission of claim 2 wherein the sleeve is coupled to a fork with a detent and the intermediate lever includes a ramp, the ramp contacting and pushing against the detent during the first movement of the intermediate lever to engage the synchronizer assembly.

4. The multi-speed transmission of claim 3 wherein the ramp remains in contact with the detent during the initial stage of the second movement of the intermediate lever, the ramp moving away from the detent during the final stage of the second movement.

5. The multi-speed transmission of claim 4 wherein the ramp has a sloped surface that is in contact with the detent during the first movement of the intermediate lever.

6. The multi-speed transmission of claim 5 wherein the sloped surface remains in contact with the detent during the initial stage of the second movement of the intermediate lever.

7. The multi-speed transmission of claim 1 further comprising a shift tower, the intermediate lever moving relative to the shift tower during the first movement and the second movement of the intermediate lever, the intermediate lever being moved in response to an operator of the multi-speed transmission.

8. The multi-speed transmission of claim 1 wherein the first movement is generally perpendicular to the second movement of the intermediate lever.

9. The multi-speed transmission of claim 1 wherein the synchronizer assembly is a fourth gear synchronizer assembly.

10. The multi-speed transmission of claim 1 wherein the first movement of the intermediate lever is a selection movement and the second movement of the intermediate lever is a shift movement.

11. A reverse gear braking mechanism for a multi-speed transmission comprising:
a reverse gear shaft member;
an idler gear connected to the reverse gear shaft member;
an intermediate lever having a first movement and a second movement, the intermediate lever selectively engaging with the reverse gear shaft member during the first movement and remaining engaged with the reverse gear shaft member during the second movement; and
a forward gear synchronizer assembly that is selectively engaged by the intermediate lever during the first movement of the intermediate lever, the synchronizer assembly remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever,
wherein the forward gear synchronizer assembly creates a braking action to stop a rotation of an input shaft and the idler gear during the first movement and the second movement of the intermediate lever.

12. The reverse gear braking mechanism of claim 11 wherein the forward gear synchronizer assembly includes a gear and a sleeve, the gear and the sleeve being coupled when the forward gear synchronizer assembly is engage and being uncoupled when the forward gear synchronizer assembly is unengaged.

13. The reverse gear braking mechanism of claim 12 wherein the sleeve is coupled to a fork with a detent and the intermediate lever includes a ramp, the ramp contacting and pushing against the detent during the first movement of the intermediate lever to engage the forward gear synchronizer assembly.

14. The reverse gear braking mechanism of claim 13 wherein the ramp remains in contact with the detent during the initial stage of the second movement of the intermediate lever, the ramp moving away from the detent during the final stage of the second movement.

15. The reverse gear braking mechanism of claim 14 wherein the ramp has a sloped surface that is in contact with the detent during the first movement of the intermediate lever.

16. The reverse gear braking mechanism claim 15 wherein the sloped surface remains in contact with the detent during the initial stage of the second movement of the intermediate lever.

17. The reverse gear braking mechanism of claim 11 wherein the first movement is generally perpendicular to the second movement of the intermediate lever.

18. A reverse gear braking mechanism for a multi-speed transmission comprising:
a reverse gear shaft member;
an idler gear connected to the reverse gear shaft member;
an intermediate lever having a first movement and a second movement that is perpendicular to the first movement, the intermediate lever selectively engaging with the reverse gear shaft member during the first movement and remaining engaged with the reverse gear shaft member during the second movement; and
a forward gear synchronizer assembly with a gear and a sleeve, the gear and the sleeve being engaged by the intermediate lever during the first movement of the intermediate lever, the gear and the sleeve remaining engaged during an initial stage of the second movement of the intermediate lever and becoming unengaged during a final stage of the second movement of the intermediate lever, the idler gear being fully engaged to achieve a reverse gear ratio during the final stage of the second movement of the intermediate lever,
wherein the forward gear synchronizer assembly creates a braking action to stop a rotation of an input shaft and the idler gear during the first movement and the second movement of the intermediate lever.

19. The reverse gear braking mechanism of claim 18 wherein the sleeve is coupled to a fork with a detent and the intermediate lever includes a ramp, the ramp contacting and pushing against the detent during the first movement of the intermediate lever to engage the forward gear synchronizer assembly.

20. The reverse gear braking mechanism of claim 19 wherein the ramp remains in contact with the detent during the initial stage of the second movement of the intermediate lever, the ramp moving away from the detent during the final stage of the second movement.
